(19) United States
(12) Patent Application Publication
(10) Pub. No.: US 2017/0083676 A1
(43) Pub. Date: Mar. 23, 2017

(54) DISTRIBUTED DENTAL SYSTEM

(71) Applicants: MICHAEL KEITH SIGLER, KANSAS CITY, MO (US); MARIA ANN KUNSTADTER, KANSAS CITY, MO (US)

(72) Inventors: MICHAEL KEITH SIGLER, KANSAS CITY, MO (US); MARIA ANN KUNSTADTER, KANSAS CITY, MO (US)

(21) Appl. No.: 14/862,921

(22) Filed: Sep. 23, 2015

(51) Int. Cl. G06F 19/00

(52) U.S. Cl. CPC G06F 19/3418; G06F 19/327; G06F 19/363

(57) ABSTRACT

A distributed dental system for assisting with the diagnosis and treatment of patients suffering from dental health issues. The system includes a number of emergency dental kiosks, each of which is located at or near an urgent care center, emergency room, or other medical facility; a central command station that receives information from and transmits information to the kiosks; and a number of computing devices operated by dentists or other dental professionals who have agreed to provide dental advice to patients who use the kiosks.

### BACKGROUND

Patients with sudden and/or severe mouth, teeth, and/or gum pain often go to urgent care centers or hospital emergency rooms rather than waiting to make an appointment to see their dentists. Unfortunately, most urgent care centers and emergency rooms do not have dental professionals on staff and therefore cannot diagnose and treat many dental problems. Instead, medical personnel at these facilities often just prescribe pain killers and/or antibiotics, neither of which treat the underlying dental problems. The patients get immediate pain relief, but often return to the same place when the pain returns. This cycle wastes valuable medical resources and frustrates the patients.

### SUMMARY

The present invention solves the above-described problems and provides a distinct advance in the treatment of patients suffering from dental problems at urgent care centers, hospital emergency rooms, and other medical facilities that are typically not staffed with dental professionals.

One embodiment of the invention is a distributed dental system for assisting with the diagnosis and treatment of patients suffering from dental problems that broadly includes a number of emergency dental kiosks, each of which is located at or near an urgent care center, emergency room, or other medical facility; a central command station that receives information from and transmits information to the kiosks; and a number of computing devices operated by dentists or other dental professionals who have agreed to provide dental advice to patients who use the kiosks. The kiosks, central command station, and computing devices may exchange information via any communications network such as the Internet, an intranet, a wireless cellular communications network, etc.

The distributed dental system may be used as follows. A patient with mouth, teeth, and/or gum pain or any other dental problem may visit an urgent care center or emergency room to seek treatment as described in the background section above. A caregiver at the urgent care center or emergency room may then take the patient to one of the kiosks of the distributed dental system. After obtaining all necessary consents, the kiosk prompts the patient or caregiver to enter certain patient information, medical information, and dental complaint information into the kiosk. The kiosk may also verify the identity of the dental patient and/or the caregiver. The kiosk then transmits at least some of the patient information, medical information, and dental complaint information to the central control station.

The central control station receives the patient information, medical information, and dental complaint information and creates and stores a patient record for the patient. The central control station may serve several kiosks and therefore may create and store patient records for many different patients.

Dental professionals who have agreed to provide dental services via the distributed dental system may then access the central control station via their computing devices. The dental professionals may then indicate if they are willing to provide diagnosis and treatment advice to any of the patients currently using one of the kiosks.

The central control station then assigns each of the patients to a dental professional who is online. The central control station may assign the patients to the dental professionals using any criteria. For example, the central control station may assign Spanish-speaking patients to Spanish-speaking dentists, patients complaining of gum pain to periodontal specialists, etc.

The dental professional assigned to a patient is then given access to the patient's record, including the stored patient information, medical information, and dental complaint information. After reviewing such information, the dentist establishes a communication with the patient trough a phone, video camera, or other communications component on the kiosk. The dental professional then provides diagnosis/treatment information to the patient and the attending caregiver via the communications component. The attending caregiver may then use the diagnosis/treatment information provided by the dentist to provide immediate treatment to the patient.

Because patients will often require follow-up treatment from a dentist who can meet with them in-person, the central control station also schedules an appointment for the dental patient with a local dental professional who works near the kiosk or the dental patient's home.

The central control station then sends a written confirmation of the diagnosis/treatment information and the scheduling information to the patient and attending caregiver via facsimile, email, or a printer located at the kiosk or elsewhere. The patient may then bring the confirmation to the scheduled dental appointment. The central control station may also fax, email, or otherwise send the confirmation directly to the local dental professional.

The distributed dental system of the present invention provides numerous advantages. For example, it allows non-dental caregivers at urgent care centers and emergency rooms to more effectively treat patients suffering from dental problems by obtaining diagnosis and treatment advice from remote dental professionals. The system also decreases the tendency of patients to repeatedly go back to the same urgent care center or emergency room when their dental problems return. The system also provides valuable dental scheduling services for dental processionals and patients.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a distributed dental system that may be used to implement aspects of the present invention.

FIG. 2 is a block diagram depicting components of a kiosk of the distributed dental system.

FIG. 3 is a block diagram depicting components of a central control station of the distributed dental system.

FIG. 4 is an exemplary screen display that may be presented by the kiosk while being used by a dental patient.

FIG. 5 is another exemplary screen display that may be presented by the kiosk while being used by a dental patient.

FIG. 6 is another exemplary screen display that may be presented by the kiosk while being a used by a dental patient.

FIG. 7 is another exemplary screen display that may be presented by the kiosk while being used by a dental patient.

FIG. 8 is an exemplary screen display that may be presented by one of the computing devices used by a dental professional while accessing the central control station.

FIG. 9 is another exemplary screen display that may be presented to the dental professional while accessing the central control station.

FIG. 10 is another exemplary screen display that may be presented to the dental professional while accessing the central control station.

FIG. 11 is another exemplary screen display that may be presented to the dental professional while accessing the central control station.

FIG. 12 is another exemplary screen display that may be presented to the dental professional while accessing the central control station.

The drawing figures do not limit the present invention to the specific embodiments disclosed and described herein. The drawings are not necessarily to scale, emphasis instead being placed upon clearly illustrating the principles of the invention.

### DETAILED DESCRIPTION

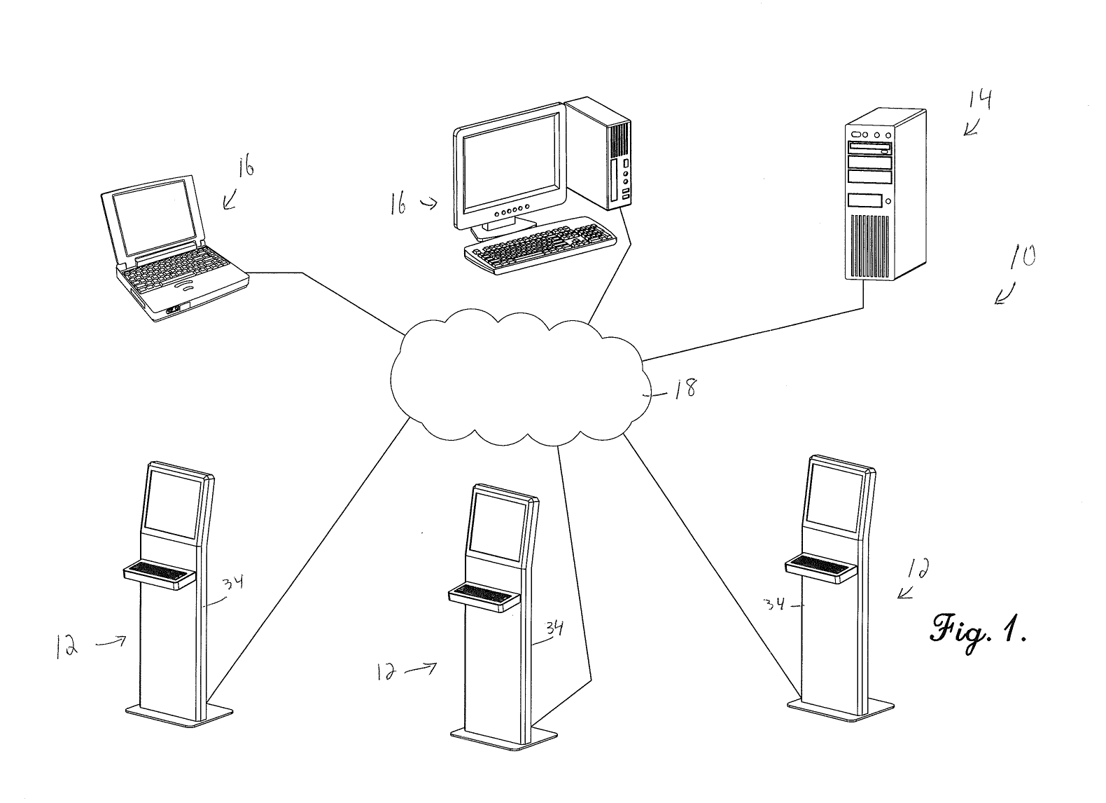

Turning now to the drawing figures, and initially FIG. 1, a distributed dental system 10 that may be used to implement aspects of the present invention is illustrated. The system 10 assists with the diagnosis and treatment of patients suffering from mouth, teeth, and/or gum pain or other dental problems and broadly includes a number of emergency dental kiosks 12; a central command station 14; and a number of computing devices 16. The kiosks 12, central command station 14, and computing devices 16 exchange information via a communications network 18 and may implement one or more computer programs for performing some of the functions described herein. Each of the major components of the distributed dental system 10 will now be described in more detail.

The kiosks 12 may be installed at or near urgent care centers, emergency rooms, or other medical facilities and are used by patients and/or their caregivers to obtain diagnosis/treatment information from dental professionals and scheduling services and information from the central command station 14. The distributed dental system 10 may include any number of kiosks 12 positioned at any locations. For example, one or more kiosks may be installed in or near hospital emergency rooms, urgent care centers, drug stores, doctor offices, etc.

As shown in FIG. 2, an embodiment of each kiosk 12 may include a processing element 20, a memory element 22, an input device 24, an identity verification component 26, a data transmission component 28, a communications component 30, a display screen 32, and an enclosure or stand 34 (FIG. 1).

The processing element 20 may include processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 20 may generally execute, process, or run instructions, code, code segments, software, firmware, programs, applications, apps, processes, services, daemons, or the like. The processing element 20 may also include hardware components such as finite-state machines, sequential and combinational logic, and other electronic circuits that may perform the functions necessary for the operation of the current invention. The processing element 20 may further include, or be in electronic communication with, circuitry to decode or convert wireless signals, as well as sampling circuits, analog to digital converters (ADCs), filtering circuits, amplifier circuits, and the like. The processing element 20 may be in communication with the other electronic components of the kiosk through serial or parallel links that include address busses, data busses, control lines, and the like.

The memory element 22 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 22 may be embedded in, or packaged in the same package as, the processing element. The memory element 22 may include, or may constitute, a “computer-readable medium.” The memory element 22 may store the instructions, code, code segments, software, firmware, programs, applications, apps, services, daemons, or the like, including the software application, that are executed by the processing element. In some embodiments, the memory element 22 may also store information in one or more databases.

The input device 24 allows a patient and/or a caregiver to enter information into the kiosk as explained in more detail below. The input device 24 may be a touchscreen display, a keypad, a keyboard, a computer mouse, a microphone, a universal serial bus (USB) port, or any combination of these components or other data entry components.

The identity verification component 26 verifies the identity of a patient and/or a caregiver that uses the kiosk. The identity verification component 26 may be the input device 24 described above (for entering user IDs, passwords, and/or other identity information), a fingerprint scanner, a retinal scanner, an image recognition device, or any combination of these components or other verification components.

The data transmission component 28 transmits information between its kiosk, the central command station 14, and the computing devices 16 as described in more detail below. The data transmission component 28 may include a radio frequency transceiver, a Wifi transceiver, a WiMAX transceiver, a Bluetooth transceiver, an ethernet port, a USB port or any other electronic device capable of transmitting or otherwise sending information to and receiving information from the central command station and/or the computing devices 16.

The communications component 30 enables voice and/or video communications between a patient and/or caregiver using the kiosk and a dental professional using one of the computing devices. The communications component may include a phone, a camera, a video conferencing device, and/or any other device that enables communications between the kiosk, the control command station, and the computing devices. The communications component 30 may also be a part of the data transmission component 28 described above.

The display screen 32 is provided for displaying diagnosis, treatment, and scheduling information received from the central command station 14 and/or the computing devices 16. The display screen 32 may employ any known display technology.

The above described components of the kiosk 12 may be housed in a single enclosure or stand 34 as shown in FIG. 1 or may be distributed amongst several housings or enclosures. In some embodiments, the above described processing element 20, memory element 22, input device 24, identity verification device 26, data transmission component 28, communications component 30, and display 32 are components of a portable computer such as a laptop computer that is integrated in the kiosk 12. In other embodiments, some or all of these components may be stand-alone components coupled to one another via wires or wireless communication elements.

The components of the kiosk 12 described above are merely examples of components that may be used to implement aspects of the present invention and may be replaced with other equipment without departing from the scope of the present invention. Some of the components of the kiosk 12 may also be combined or even omitted.

The central control station 14 will now be described in more detail. The central control station 14 may be operated by or for an administrator of the distributed dental system 10. For example, the central control system may be operated by a dentist referral agency, a health maintenance organization, a health insurance company, a hospital or hospital network, or any other medical institution. The central control station 14 receives, stores, and provides access to the information transmitted from the kiosks 12 and serves as a portal that can be accessed by the computing devices 16 and other devices as described in more detail below. The central control station 14 may implement one or more computer programs for performing some of the functions described herein.

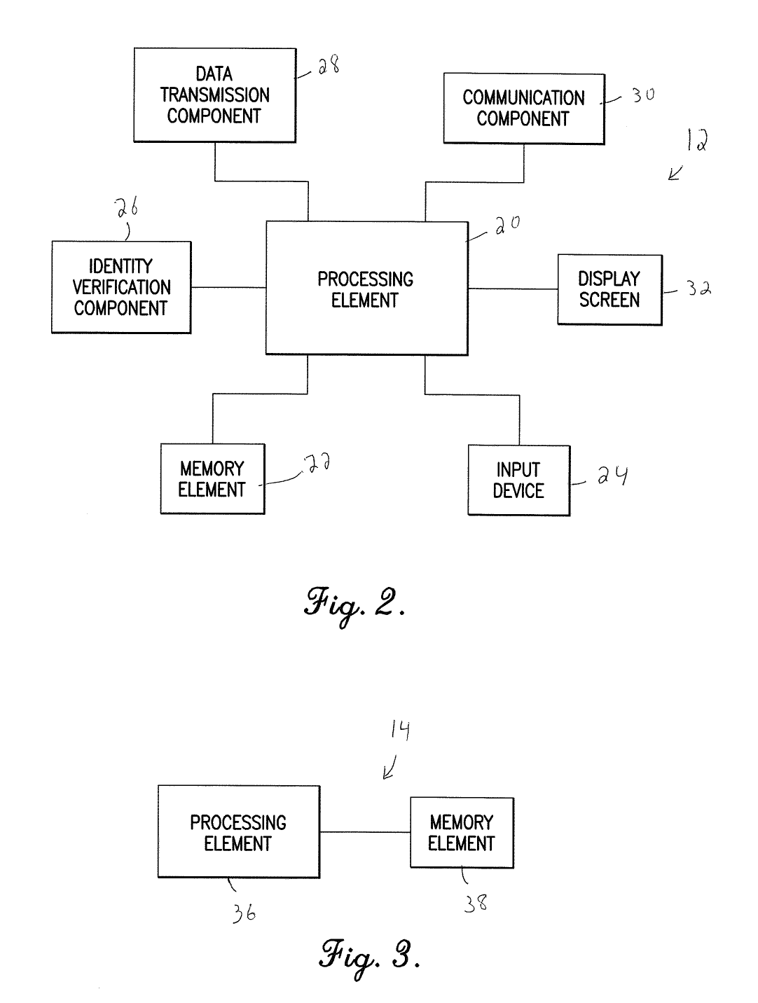

Embodiments of the central control station 14 may include a processing element 36 and a memory element 38 as shown in FIG. 3. The processing element 36 may include processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 36 may generally execute, process, or run instructions, code, code segments, software, firmware, programs, applications, apps, processes, services, daemons, or the like. The processing element 36 may also include hardware components such as finite-state machines, sequential and combinational logic, and other electronic circuits that may perform the functions necessary for the operation of the current invention. The processing element may further include, or be in electronic communication with, circuitry to decode or convert wireless signals, as well as sampling circuits, analog to digital converters (ADCs), filtering circuits, amplifier circuits, and the like. The processing element may be in communication with the other electronic components through serial or parallel links that include address busses, data busses, control lines, and the like.

The memory element 38 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the processing element. The memory element 38 may include, or may constitute, a “computer-readable medium.” The memory element 38 may store the instructions, code, code segments, software, firmware, programs, applications, apps, services, daemons, or the like, including the software application, that are executed by the processing element. In some embodiments, the memory element may also store some or all of the database.

Some embodiments of the central control station 14 store patient records and other information in a database. The database may have a traditional database structure including fields, keys, arrays, tables, linked lists, and the like with a database manager to provide or control access to the data. Furthermore, the database may include data that is accessible via the Internet. The database may be stored in the memory element of the computing device, on one or more servers that are accessible by the computing device, or combinations thereof

The central control station 14 may also include conventional web hosting operating software, searching algorithms, an Internet connection, and may be assigned a URL and corresponding domain name so that it can be accessed via the Internet in a conventional manner.

The computing devices 16 will now be described in more detail. The computing devices 16 are operated by dentists or other dental professionals who have agreed to provide dental diagnosis and treatment to patients who use the kiosks 12. The computing devices 16 may be desktop computers, laptop computers, tablet computers, mobile phones, or any other electronic devices. Each computing device 16 preferably includes or can access an Internet browser and a conventional Internet connection such as a wireless broadband connection, DSL converter, or ISDN converter so that it can exchange data with the central control station via the communications network. Each computing device 16 may be programmed with an application or other computer program for implementing some of the functions of the present invention.

The communication network 18 allows communication between the kiosks 12, central control station 14, and computing devices 16. The communication network 18 may include local area networks, metro area networks, wide area networks, cloud networks, the Internet, cellular networks, plain old telephone service (POTS) networks, and the like, or combinations thereof. The communication network 18 may be wired, wireless, or combinations thereof and may include components such as modems, gateways, switches, routers, hubs, access points, repeaters, towers, and the like. The kiosks 12, central control station 14, and computing devices 16 may connect to the communication network 18 either through wires, such as electrical cables or fiber optic cables, or wirelessly, such as RF communication using wireless standards such as cellular 2G, 3G, or 4G, Institute of Electrical and Electronics Engineers (IEEE) 802.11 standards such as WiFi, IEEE 802.16 standards such as WiMAX, Bluetooth™, or combinations thereof.

The components of the distributed dental system 10 illustrated and described herein are merely examples of equipment that may be used to implement embodiments of the present invention and may be replaced with other equipment without departing from the scope of the present invention.

Embodiments of the present invention may also comprise one or more computer programs stored in or on computer-readable medium residing on or accessible by the kiosks 12, central control station 14, and/or the computing devices 18. The computer programs may comprise listings of executable instructions for implementing logical functions in the computers and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The distributed dental system 10 described above and variations thereof may be used as follows. The kiosks 12 are first installed in urgent care centers, emergency rooms, or other medical facilities. Although the kiosks may be installed anywhere, they are particularly suitable for facilities that are staffed by doctors, nurses, and/or other medical professionals who do not specialize in dental or oral medicine. Communications are then established between the kiosks 12 and the central control station 14 via the communications network 18. As part of an initial set-up procedure, location information for each kiosk may be stored in memory of the central control station 14.

The administrator or other operator of the central control station 14 then recruits a network of dentists or other dental health professionals who are willing to consult with patients who use the kiosks 12. These dental health professionals do not need to be in the same geographic area of any of the kiosks and may in fact be far distances from the kiosks.

The dental professionals are then told how to access the central control station 14 and information stored thereon. The dental professionals may be assigned user IDs and passwords so that the patient records and other information stored on the central control station 14 can only be viewed by authorized persons.

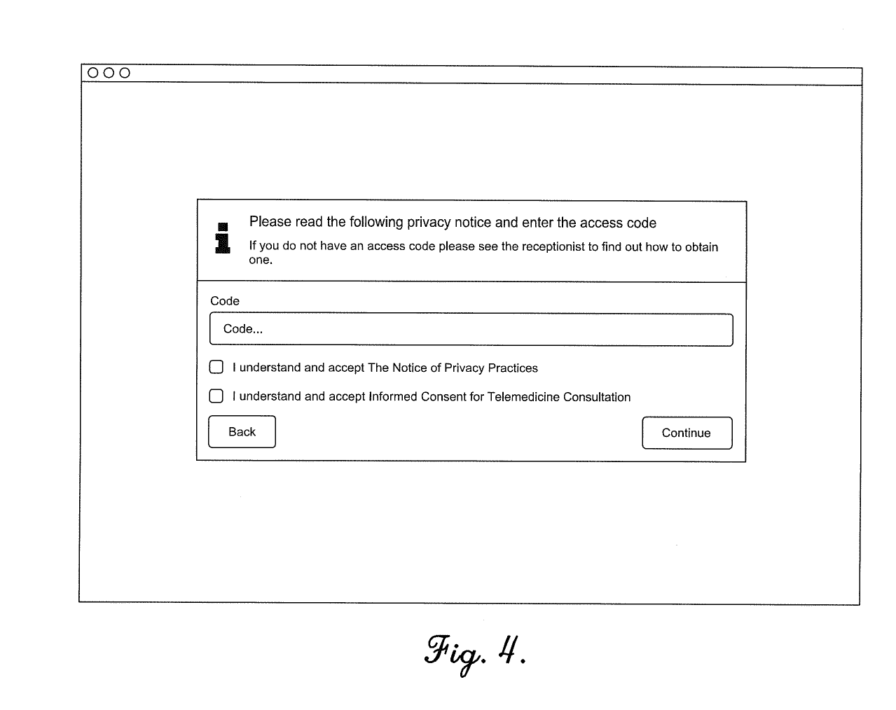

Once the distributed dental system 10 is installed and set-up, it may be used to provide diagnosis and treatment information and dental appointment scheduling services to patients with mouth, teeth, and/or gum pain or any other dental problems who visit an urgent care center or emergency room to seek treatment. For example, a caregiver at an urgent care center or emergency room may determine that a patient is suffering from a dental problem and may take the patient to the closest kiosk 12. Once the kiosk is accessed, it first displays a privacy notice and consent form that must be read and accepted by the patient before proceeding. An exemplary screen display for a privacy notice and consent is shown in FIG. 4.

The kiosk 12 may then verify the identity of the patient and/or the caregiver. For example, the patient may be required to enter his or her social security number or other identifying information and then create a password-protected account. Or, the dental patient's identity may be verified with a fingerprint scanner, retinal scanner, or other biometric device.

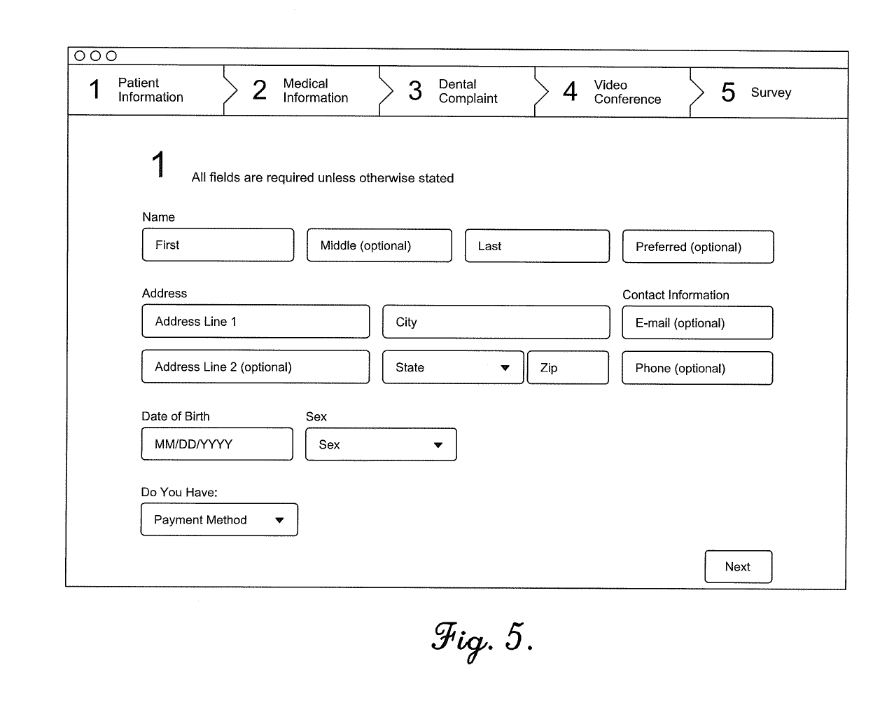

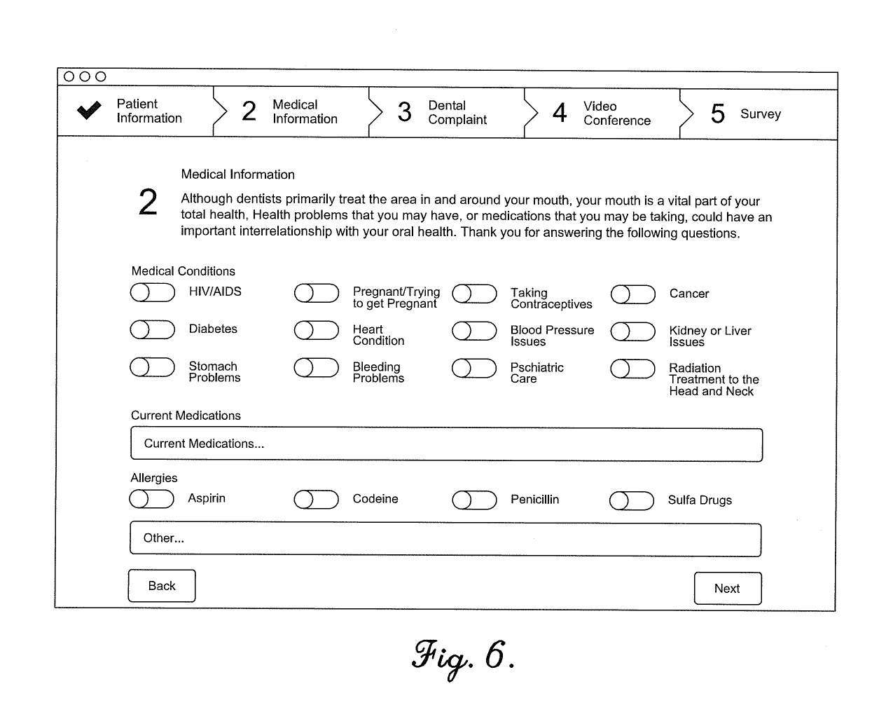

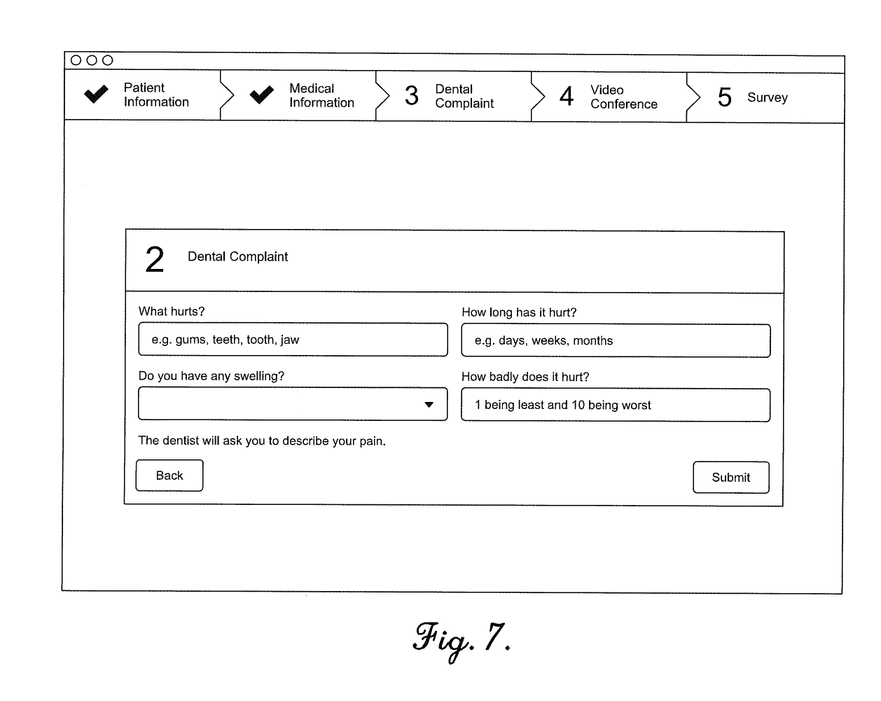

The kiosk 12 then prompts the patient or caregiver to enter information that will be used to create a patient record for the patient. In one embodiment, the kiosk 12 prompts the patient to enter patient information, medical information, and dental complaint information. For example, as shown in FIG. 5, the kiosk may prompt the patient to enter the following patient information: name, address, contact information, date of birth, sex, and health insurance information. Similarly, as shown in FIG. 6, the kiosk may prompt the patient to enter the following medical information: an indication of existing medical conditions, information about any medications being taken by the patient, and an indication of any allergies suffered by the patient. Finally, as shown in FIG. 7, the kiosk may prompt the patient to enter the following dental complaint information: an indication of what part of the patient's mouth, teeth, or gums hurt; an indication of how long the dental patient's mouth, teeth, or gums have hurt; and an indication of how badly the dental patient's mouth, teeth, or gums hurt.

The kiosk 12 then transmits at least some of the patient information, medical information, and dental complaint information to the central control station 14. The central control station 14 then uses at least some of the information to create and store a patient record for the patient. The central control station 14 serves numerous kiosks and therefore creates and stores many patient records in a database or other memory structure.

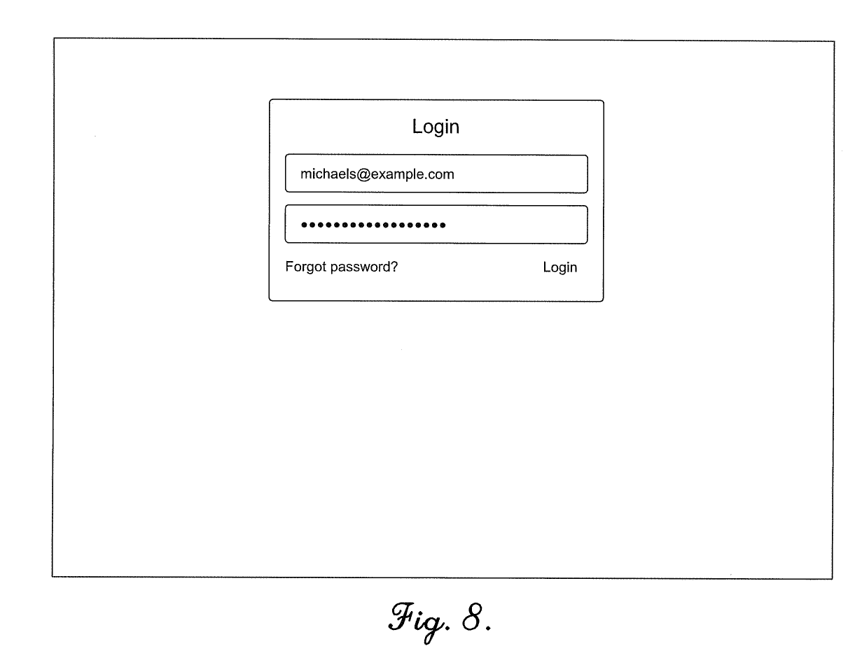

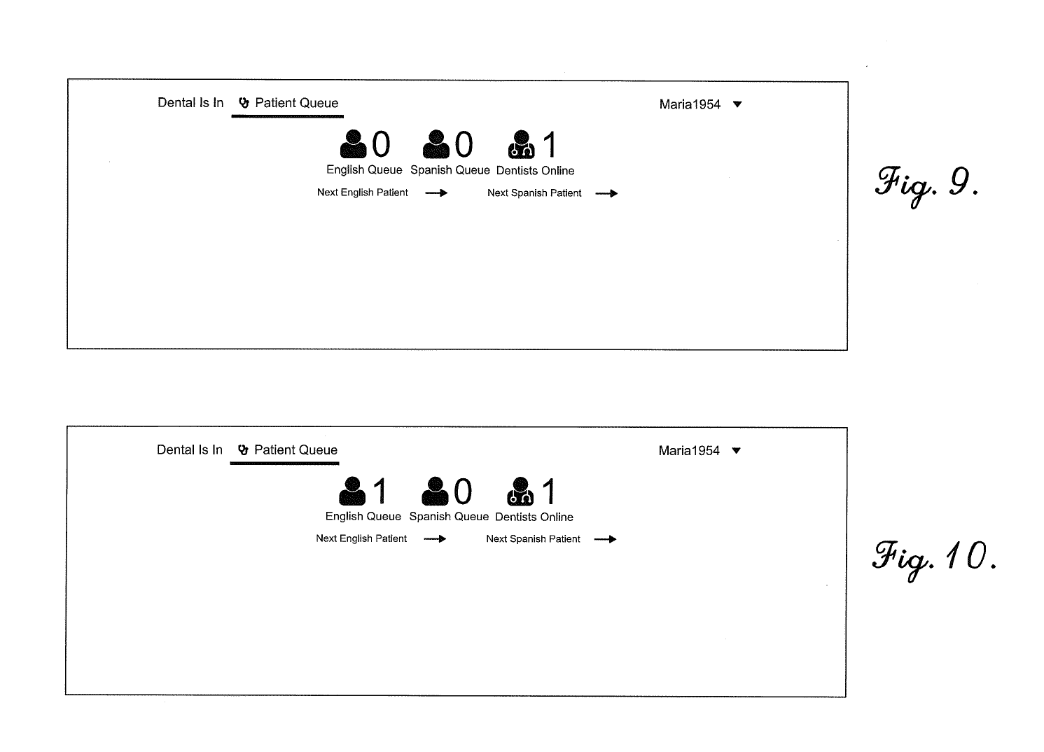

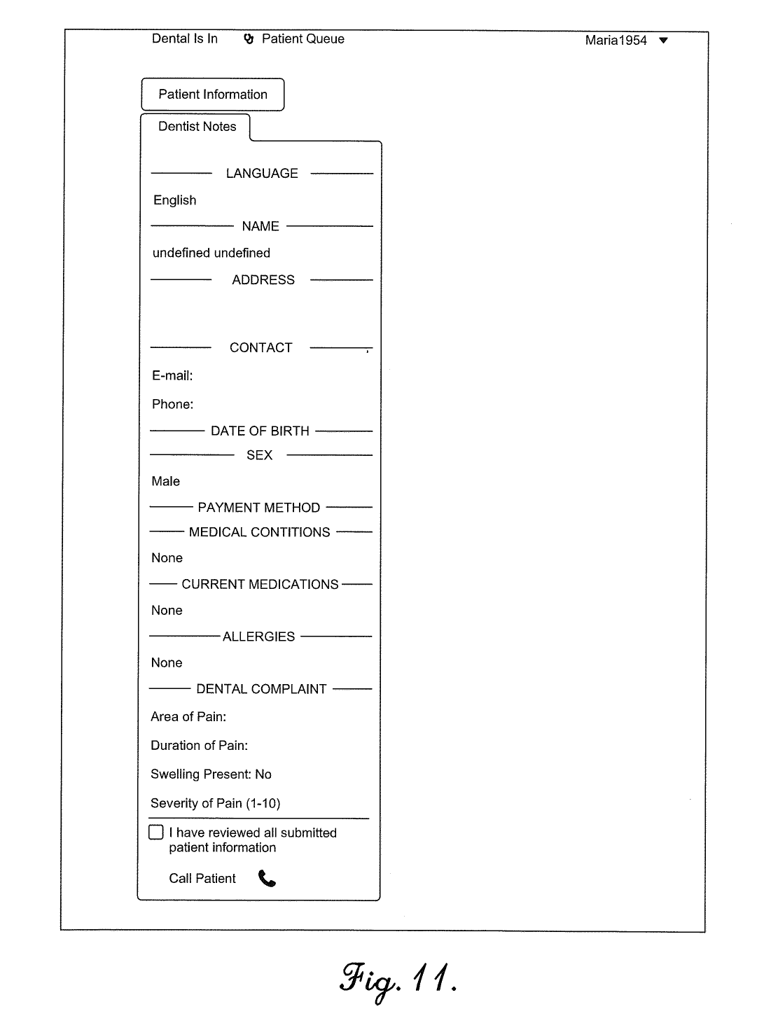

While patients use the kiosks as described above, dental professionals may access the central control station 14 via their computing devices 16 to provide remote, online diagnosis and treatment services to the patients. The dental professionals may first be required to login to the central control station using a login screen such as the one shown in FIG. 8. The central control station 14 may then display a screen that indicates the number of patients currently using the kiosks and the number of dental professionals available to assist them. For example, the screen shot of FIG. 9 shows that one dentist is online but no patients are currently using a kiosk. Similarly, the screen shot of FIG. 10 shows that one dentist is online and one English speaking patient is using one of the kiosks. These screen shots may also include links that allow the online dentists to claim the next available patient.

The central control station 14 then assigns each patient to an available dentist. The central control station 14 may assign the patients to dental professionals using any criteria. For example, Spanish-speaking patients may be assigned Spanish-speaking dentists, patients complaining of gum pain may be assigned to periodontal specialists, juvenile patients may be assigned to pediatric dentists, etc. In other embodiments, the patients may be assigned to dental professional, in the order the dental professionals access the central control station.

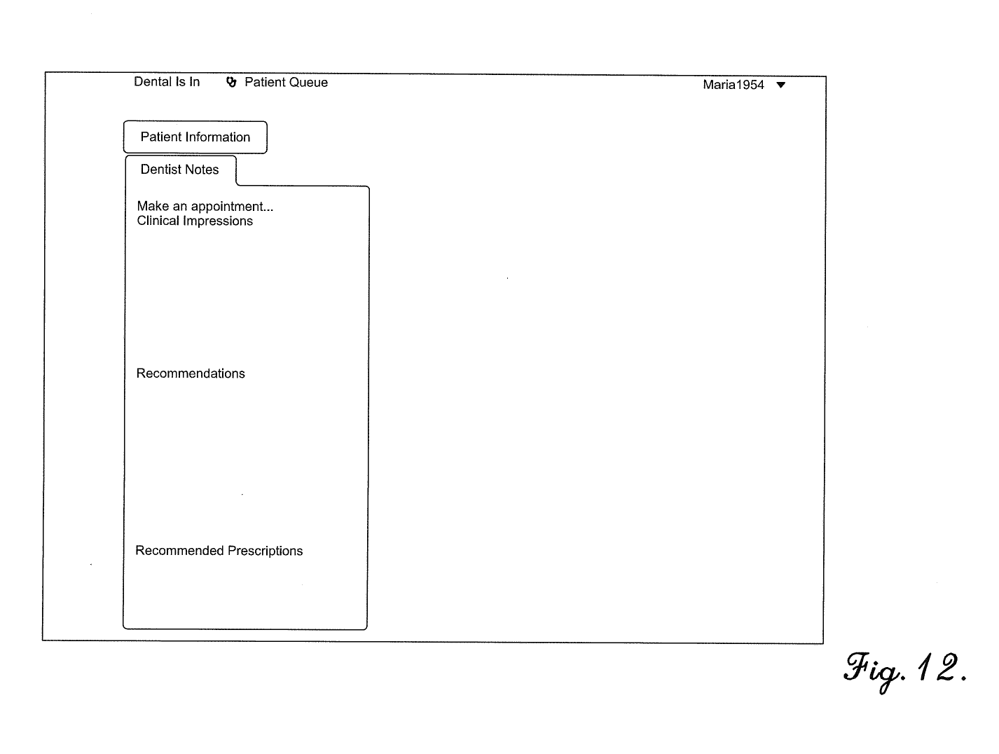

A dental professional assigned to a particular patient is then given access to the patient's patient record, including the medical information and dental complaint information the patient entered in the kiosk. For example, the dental professional may be presented with a screen such as the one shown in FIG. 11. After reviewing such information and confirming that it was reviewed, the dentist establishes a communication with the patient trough the phone, video camera, or other communications component on the kiosk. In some embodiments, the dentist may instruct the patient to provide video images of the afflicted area of their mouth via the camera in the kiosk. The dental professional then provides diagnosis/treatment information to the patient and the attending caregiver via the communications component 30 and/or the display screen 32 on the kiosk. The dental professional may also add notes to the patient's record stored on the central control station using the screen of FIG. 12. The attending caregiver may then use the diagnosis/treatment information provided by the dentist to provide immediate treatment to the patient.

Because the attending caregiver is likely only able to provide diagnosis information and some treatment, the central control station 14 also schedules an appointment for the patient with a local dental professional who works near the kiosk or the dental patient's home. Appointments may be made using ZocDoc or any other on-line service or program. The central control station then sends scheduling information for the appointment to the kiosk.

The central control station 14 then sends a written confirmation of the diagnosis/treatment information and the scheduling information to the patient and attending caregiver via facsimile, email, or a printer located at the kiosk. The caregiver may use this information while providing immediate treatment to the patient as mentioned above and the patient may then bring the confirmation information to the scheduled dental appointment. The central control station 14 may also fax, email, or otherwise send the confirmation directly to the local dental professional with whom the patient is scheduled to meet.

The distributed dental system 10 of the present invention provides numerous advantages. For example, it allows non-dental caregivers at urgent care centers, emergency rooms, and other facilities to more effectively treat patients suffering from dental problems by obtaining diagnosis and treatment advice from dental professionals. The system also decreases the tendency of patients to repeatedly go back to the same urgent care center or emergency room when their dental pain resumes. The system also provides valuable dental scheduling services for dental processionals and patients.

The present invention addresses an Internet-centric challenge or problem with a solution that is necessarily rooted in computer technology. Specifically, the invention addresses the challenges of providing dental services via the Internet without sacrificing the medical care provided by a local or resident caregiver. Moreover, the novel steps performed by the central control system and kiosks advantageously improves the technological process of providing remote dental services via computer technology.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A kiosk for assisting with diagnosis and treatment of patients suffering from dental problems, the kiosk comprising:
an input device for receiving patient information, medical information, and dental complaint information from a patient;
an identity verification component for verifying an identity of the patient or a caregiver who is treating the patient;
a data transmission component for transmitting at least some of the patient information, medical information, and dental complaint information from the kiosk to a central control station;
a communications component for receiving diagnosis/treatment information from a dentist who has reviewed the patient information, medical information, and dental complaint information, the communications component further configured to receive scheduling information from the central control station, the scheduling information including information for an appointment with a dentist within a prescribed distance from the kiosk; and
an enclosure for supporting the input device, the identity verification component, the data transmission component, and the communications component.

2. The kiosk of claim 1, wherein the communications component includes a phone for enabling voice communications between the patient and the dentist.

3. The kiosk of claim 1, further comprising a display screen for displaying the diagnosis/treatment information from the dentist.

4. The kiosk of claim 2, wherein the communications component further includes a camera and video conferencing capabilities for enabling audio and video communications between the patient and the dentist.

5. The kiosk of claim 1, wherein the input device is selected from the group consisting of a touchscreen display, a keypad, and a keyboard.

6. The kiosk of claim 1, wherein the identity verification component is selected from the group consisting of an input device for entering identity information, a fingerprint scanner, a retinal scanner, and an image recognition device.

7. The kiosk of claim 1, wherein the input device, the identity verification device, the data transmission component, and the communications component are integrated components of a portable computer.

8. The kiosk of claim 1, wherein the patient information includes the patient's name, address, contact information, date of birth, sex, and health insurance information.

9. The kiosk of claim 1, wherein the medical information includes an indication of medical conditions of the patient, information about any medications being taken by the patient, and an indication of any allergies suffered by the patient.

10. The kiosk of claim 1, wherein the dental complaint information includes an indication of what part of the patient's mouth, teeth, or gums hurt; an indication of how long the patient's mouth, teeth, or gums have hurt; and an indication of how badly the patient's mouth, teeth, or gums hurt.

11. An emergency dental diagnosis system comprising:
a kiosk comprising:
an input device for receiving patient information, medical information, and dental complaint information from a patient suffering from a dental problem;
an identity verification component for verifying an identity of the patient or a caregiver who is treating the patient;
a data transmission component for transmitting at least some of the patient information, medical information, and dental complaint information; a communications component for receiving communications;
an enclosure for supporting the input device, the identity verification component, the data transmission component, and the communications component in the vicinity of a medical facility at which the caregiver works; and
a central control station that communicates with the kiosk and other kiosks via a communications network, wherein the central control station is programmed with at least one computer program stored on non-transitory computer readable medium to instruct the central control station to perform the following steps:
receive the patient information, medical information, and dental complaint information transmitted from the kiosk;
enable a dentist to access the patient information, medical information, and dental complaint information via a computing device that accesses the central control station;
enable the dentist to provide diagnosis/treatment information to the dental patient via the central control station and the kiosk;
provide scheduling information to the dental patient via the kiosk, wherein the scheduling information identifies an appointment with a dentist within a prescribed distance from the kiosk.

12. The emergency dental diagnosis system of claim 11, wherein the communications component includes a phone for enabling voice communications between the patient and the dentist.

13. The emergency dental diagnosis system of claim 11, further comprising a display screen for displaying the diagnosis/treatment information from the dentist.

14. The emergency dental diagnosis system of claim 12, wherein the communications component further includes a camera and video conferencing capabilities for enabling audio and video communications between the patient and the dentist.

15. The emergency dental diagnosis system of claim 11, wherein the input device is selected from the group consisting of a touchscreen display, a keypad, and a keyboard.

16. The emergency dental diagnosis system of claim 11, wherein the identity verification component is selected from the group consisting of an input device for entering identity information, a fingerprint scanner, a retinal scanner, and an image recognition device.

17. The emergency dental diagnosis system of claim 11, wherein the input device, the identity verification device, the data transmission component, and the communications component are components of a portable computer.

18. The emergency dental diagnosis system of claim 11, wherein the patient information includes the patient's name, address, contact information, date of birth, sex, and health insurance information.

19. The emergency dental diagnosis system of claim 11, wherein the medical information includes an indication of medical conditions of the patient, information about any medications being taken by the patient, and an indication of any allergies suffered by the patient.

20. The emergency dental diagnosis system of claim 11, wherein the dental complaint information includes an indication of what part of the patient's mouth, teeth, or gums hurt; an indication of how long the patient's mouth, teeth, or gums have hurt; and an indication of how badly the patient's mouth, teeth, or gums hurt.
